(19) United States
(12) Patent Application Publication
(10) Pub. No.: US 2013/0061481 A1
(43) Pub. Date: Mar. 14, 2013

(54) Safety razor

(71) Applicant: Sean Joseph Cooney, East Hartford, CT (US)

(72) Inventor: Sean Joseph Cooney, East Hartford, CT (US)

(21) Appl. No.: 13/199,735

(22) Filed: Sep. 8, 2011

(51) Int. Cl. B26B 21/52

(52) U.S. Cl. 30/526

(57) ABSTRACT

The safety razor includes a disc-like handle having a concavity on at least one side to facilitate secure grasping of the razor between only two fingers. A recess may be formed into the opposite side of the handle for receipt of photographs, indicia-bearing elements, and the like, and for engagement of an overlying, retaining insert. The surfaces on the opposite sides of the handle also provide areas for carrying graphic and/or textual matter.

### BACKGROUND OF THE INVENTION

Safety razors are conventionally of generally T-shaped construction, comprised of an elongate handle and a perpendicular blade-holding head centrally joined at one end. This construction imposes constraints upon the manner of use (e.g., the thumb and at least three fingers of the user's hand are normally required to grip the handle with good stability), upon the ability to manipulate the razor, and upon the packaging used; the standard handle shape also limits the applications for, and aesthetic attributes of, conventional T-shaped razors.

### BRIEF SUMMARY OF THE INVENTION

It is a broad object of the invention to provide a safety razor of unique construction, which affords benefits for gripping, manipulation, manufacture, and packaging, as well as embodying novel aesthetic features.

It is also an object of the invention to provide a razor having the foregoing features and advantages, which employs a handle component having utility for other purposes.

It has now been found that certain of the foregoing and related objects of the invention are attained by the provision of a safety razor comprised of a head and a handle joined substantially directly to one another, the head including at least one elongate blade extending along a longitudinal axis. The handle is of generally disc-like form, and is disposed generally on a plane to which the longitudinal axis of the blade is substantially parallel; at least one of the opposite sides of the handle is formed with a recess for receiving part of a user's finger, particularly his or her thumb. Normally, the recess in the “at least one” opposite side of the handle will be generally concave, and the other of the opposite sides of the handle will usually be formed with a finger portion-receiving recess as well.

In attainment of additional objects of the invention, the recess in the other opposite side of the handle may be of such form as to adapt it for the receipt and engagement therein of an insert piece, which may be temporarily or permanently engaged and will preferably be made, at least partially, of a transparent material. Such a razor may include a graphic and/or textual element disposed within the recess and visible beneath an outer transparent portion of the insert piece, or the insert piece itself may be decorated, embossed, imprinted or otherwise embellished with graphic and/or textual material.

In any event, the head and handle of the razor will desirably be joined to one another by mated elements, one preferably being in the form of a protrusion and the other being socket structure dimensioned and configured for receipt, and temporary or permanent engagement of, the protruding element. Such a protrusion on the handle will advantageously extend from its circumference, generally in the plane thereof, and may desirably be constructed for attachment to a jewelry chain, string, ring, bracelet, band, or like article, thus enabling the disconnected handle to function as a pendant in cooperation with such an attached article.

### BRIEF DESCRIPTION OF THE SEVERAL VIEWS OF THE DRAWINGS

FIG. 1 is a front perspective view showing a first form of a safety razor embodying the present invention, hand-held for use;

FIG. 2 is a rear elevational view of the safety razor of FIG. 1;

FIG. 3 is an exploded perspective view of the safety razor depicted in the foregoing figures.

FIG. 4 is an elevational view of the handle component of the safety razor, taken from the front or the rear (the component being symmetric about its medial plane);

FIG. 5 is a right or left elevational view of the handle component, which is symmetric about its centerline as well;

FIG. 6 is a sectional view of the handle component, taken along line 6-6 in FIG. 4;

FIG. 7 is a perspective view showing the handle component of a second embodiment of the safety razor of the present invention, attached as a pendant on a string (shown fragmentarily); and

FIG. 8 is an enlarged sectional view of the handle component depicted in FIG. 7, taken along line 8-8 therein.

### DETAILED DESCRIPTION OF THE INVENTION

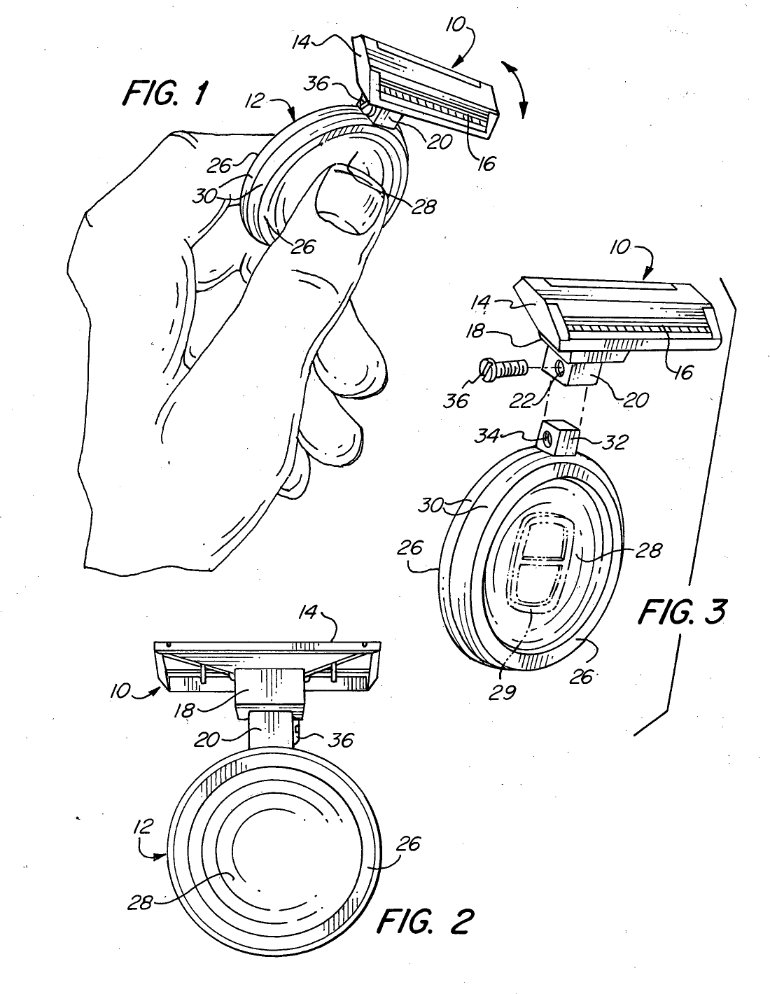

Turning initially to FIGS. 1 through 3 of the appended drawings, therein illustrated is a safety razor embodying the present invention and consisting of a head component and a substantially directly joined handle component, generally designated, respectively, by the numerals 10 and 12. The head component includes an elongate head member 14 in which a longitudinally extending blade 16 is secured; although only a single blade is illustrated it will be appreciated that the head member 14 may contain a multiplicity of parallel blades if so desired. The head member 14 is joined to a base element 18, which is in turn pivotally mounted (as indicated by the double-headed arrow) on socket structure 20; an aperture 22 is formed through one wall of the structure 20.

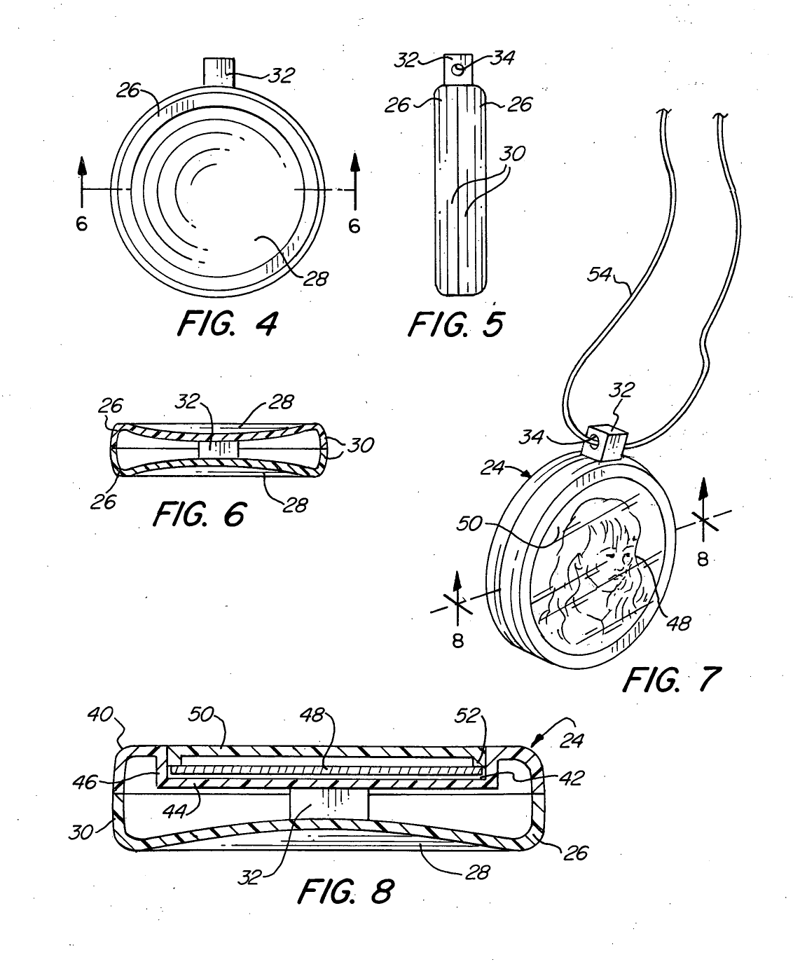

With additional reference now to FIGS. 4 through 6, it can be seen that the handle component 12 is constructed from two substantially identical molded plastic pieces 26, each having a central, concave, generally circular wall portion 28 surrounded by a circumferential flange 30. The flanges 30 are joined edgewise, in confronting relationship to one another, by adhesive bonding, fusion welding, or other appropriate means, to form a hollow disc-like body. The body (i.e., essentially the handle component) will typically be about 1¼ to 1¾ inch in diameter and about ¼ to ⅝ inch thick, measured at the edge, but those dimensions will vary depending upon the manner of construction and the materials used, the particular features incorporated, etc.; the handle component can be of solid construction, if preferred, and can be fabricated from any suitable material, as will be evident to those skilled in the art.

A small lug, or male element, 32 extends radially from the circumference of the body that is formed by the joined pieces 26, and has a threaded, transverse aperture 34 (i.e., the aperture 34 extends generally tangentially to, and in the medial plane of, the body). The lug 32 may be integral with one or both of the molded pieces 26 (in which case it will be appreciated that they may not be identical), or it may be provided as a separate part, secured in place.

As will be readily appreciated (and is depicted in FIG. 3), the head component 10 is attached to the handle component 12 by inserting the lug 32 into the space defined within the socket structure 20 on the head component 10. A screw 36 (desirably made of plastic) is inserted through the aperture 22 in the socket structure 20 and engaged in the threaded aperture 34 in the lug 32 to maintain the components in assembly.

As indicated in FIG. 1, the handle component 12 is normally gripped with the user's thumb placed within the concavity of the central portion 28 of the molded piece 26 on the front side of the razor assembly, and with the knuckle of his forefinger received within the corresponding concavity at the rear. A strong, two-fingered grip is thereby enabled, permitting unencumbered manipulation of the head component 10 so as to afford a highly convenient, effective, and safe shaving procedure. It might be mentioned that the razor described could often be used by people who are disabled, either because all fingers on a hand other than the thumb are missing or distorted, or because they lack normal usage for other reasons. As an optional feature, moreover, the surfaces of the concavities may be embellished, such as by the provision of the square figure “8” element 29 shown in broken line FIG. 3; indeed, element 29 represents an embossment which may (like numerous other possible modifications) serve to enhance the user's grip on the handle component.

Turning now in detail to FIGS. 7 and 8 of the drawings, therein illustrated is a handle component, generally designated by the numeral 24, in which one of the molded pieces 26 employed in the embodiment of FIGS. 1 through 6 is replaced with a modified molded piece 40. Although not shown in these figures, it will be appreciated that the handle component 24 will normally be assembled with a razor head component 10 in the manner described and illustrated in FIGS. 1 through 3, usually with the modified piece 40 disposed to the rear of the razor (i.e., to enable receipt of the user's thumb in the depression 28 of the piece 26 at the front).

The molded piece 40 is formed to provide a shallow well 42, defined by a circular bottom wall 44 and a short cylindrical sidewall 46. A photograph, printed on a circular piece of paper 48, is seated at the bottom of the well 42 against the wall 44. It is held in place by a circular insert piece, generally designated by the numeral 50, comprised of a top wall 51 and a circumferential lip 52, the lip 52 serving not only produce a frictional fit against the surface of the sidewall 46 (preferably being water-tight and air-tight), to maintain the insert in assembly, but also to hold the photograph 48 in place against the bottom wall 44. The insert piece 50 is fabricated from a transparent plastic material, so that the image of the photograph 48 can be viewed therethrough, as illustrated in FIG. 7. A string 54 is threaded through the aperture 34 in the lug 32, enabling the handle component 24 to function as a pendant-like novelty. Needless to say, after disconnection from the razor head component a chain, bracelet, wristband, key ring, or the like may alternatively be attached to the handle component 24, as desired. Depending upon the nature of the photograph 48 or other element contained within the well 42 (which may for example bear a slogan, a logo, identification information, etc.) such an article may be used for decorative, advertising, medical alert, and other similar purposes.

It should be appreciated that the components of the razor will be joined to one another by any appropriate means, such as (in addition to threaded fasteners of the kind described), rivets, pegs, pins, snap-fit interengaging elements, ball-and-detent arrangements, adhesive or fusion bonding, etc. As will be appreciated, therefore, the attachment may be either permanent or temporary.

Thus, it can be seen that the present invention provides a safety razor of unique construction, which affords benefits for gripping, manipulation, packaging, and manufacture, as well as providing novel aesthetic features. The handle of the razor is normally gripped between the user's thumb and forefinger, albeit only the thumb, and an opposing part of the hand, would be sufficient in many cases, thus enabling certain handicapped individuals to shave themselves independently. The absence of a long handle on the razor may be found to facilitate manipulation; the unique shape and construction of the handle component adapts the razor for novel packaging concepts; and it may contribute to a minimization of manufacturing costs. The handle component may be formed with a recess for engagement and containment of inserts of various kinds; but, as noted above, even in the absence of such a recess and engageable insert piece the circular areas on the handle inherently provide spaces for attaching, imprinting, embossing, or otherwise displaying messages, decoration, personalization, etc.; indeed, the handle can serve those purposes irrespective of whether it is detachable from the head component.

Having thus described the invention, what is claimed is:

1. A safety razor comprised of a head and a handle joined substantially directly to one another; said head including at least one elongate blade extending along a longitudinal axis; and said handle being of generally disc-like form, with opposite sides and disposed generally on a plane containing said longitudinal axis of said at least one blade or to which said longitudinal axis is at least substantially parallel, at least one of said opposite sides of said handle being formed with a recess for receipt of a portion of a user's finger.

2. The razor of claim 1 wherein said recess in said at least one opposite side of said handle is generally concave and circular.

3. The razor of claim 1 wherein the other of said opposite sides of said handle is also formed with a recess.

4. The razor of claim 3 wherein said recess in said other opposite side of said handle is formed for receipt of a portion of a user's finger.

5. The razor of claim 3 wherein said recess in said other opposite side of said handle is formed for the receipt, and engagement therein, of an insert piece.

6. The razor of claim 5 additionally including an insert piece received and temporarily or permanently engaged in said other opposite side recess of said handle.

7. The razor of claim 6 wherein said insert piece includes at least an outer portion made of a transparent material, and wherein said razor further includes a graphic and/or textual element disposed within said other opposite side recess beneath said outer portion of said insert piece and visible therethrough.

8. The razor of claim 1 wherein said head and said handle have mated joining elements thereon.

9. The razor of claim 8 wherein one of said joining elements is a protruding element and the other of said joining is being socket structure dimensioned and configured for receipt, and temporary or permanent engagement, of said protruding element therein.

10. The razor of claim 8 wherein said joining elements are disengageable from one another and wherein said joining element on said handle extends from the circumference, and generally in said plane, thereof.

11. The razor of claim 8 wherein said joining element on said handle is a protruding element and is constructed for attachment of a jewelry chain, string, ring, bracelet, band, or the like to function as a pendant in cooperation therewith.

12. The razor of claim 11 wherein said protruding element has a through aperture for attachment of a jewelry chain, string, ring, bracelet, band, or the like.
